(19) United States
(12) Patent Application Publication
(10) Pub. No.: US 2004/0011192 A1
(43) Pub. Date: Jan. 22, 2004

(54) Electrohydraulic circuit for control of a fluid pressure actuator

(75) Inventors: Salvatore Frediani, Aosta (IT); Marco Margaria, Piasco (IT)

Correspondence Address: SUGHRUE MION, PLLC, 2100 PENNSYLVANIA AVENUE, N.W., WASHINGTON, DC, 20037, US

(73) Assignee: C.R.F. SOCIETA CONSORTILE PER AZIONI

(21) Appl. No.: 10/442,990

(22) Filed: May 22, 2003

(30) Foreign Application Priority Data
May 23, 2002 (IT) TO2002A000440

(51) Int. Cl. F16K 31/12

(52) U.S. Cl. 91/459; 251/31; 91/465

(57) ABSTRACT

The circuit comprises first and second power lines connected to a port of a first actuator chamber and to the port of a second actuator chamber, respectively; a supply line and a discharge line connected to a supply source and to a discharge reservoir; a first sliding member valve capable of connecting the first power line to the supply and discharge lines under the control of pilot pressures transmitted to the first sliding member valve by a first pair of pilot lines; and a second sliding member valve capable of connecting the second power line with the supply and discharge lines under the control of pilot pressures transmitted to the second sliding member valve by a second pair of pilot lines. The one line of the first pair of pilot lines and the one line of the second pair of pilot lines transmit the same first pilot pressure signal; the other line of the first pair of pilot lines and the other line of the second pair of pilot lines transmit the same second pilot pressure signal, whereby the actuator can be controlled by only two pilot pressures.

### BACKGROUND OF THE INVENTION

The present invention relates to a circuit for the control of a double-acting fluid pressure actuator. According to a first aspect of the invention, the control circuit comprises two three-way, three-position, continuously adjustable directional control valves, each controllable by a pair of pilot pressures. According to a further aspect of the invention, the control circuit comprises four two-way, two-position directional control valves with continuously adjustable sliding members, each controllable by a respective pilot pressure.

In order to make it easier to read and understand the description of the invention, terms such as “circuit”, “actuator” or “directional control valve” will hereinafter be used without adding the adjectives “hydraulic” or “pneumatic” thereto, it being apparent that the invention relates to hydraulic or pneumatic circuits, that is, circuits which exploit a working fluid.

To control the movement of a double-acting actuator it is known for example to use a four-way, three-position directional control valve controllable by a pair of pilot pressures.

Referring to FIG. 1 of the attached drawings, a double-acting actuator is generally indicated 10 and a four-way, three-position, continuously adjustable directional control valve is indicated 100.

The actuator 10 comprises a rear chamber 16 connectable to the outside through a port A, and a front chamber 17 connectable to the outside through a port B. The directional control valve 100 is interposed between a pair of power lines 12 and 13 connected to the port A and the port B of the actuator 10, respectively, and a pair of power lines 14 and 15, that is, a supply line and a discharge line, connected to a pump P and to a reservoir T, respectively. A pair of proportional solenoid valves 20 and 21 are arranged to generate respective pilot pressures p₁ and p₂, which via respective pilot lines 18 and 19 act in opposite directions on identical control surfaces S of the sliding member of the directional control valve 100 to move this latter from a rest position 0 to one of two working positions 1 and 2.

The directional control valve 100 is of the normally-closed type, that is to say in the rest position 0 it closes both the power lines 12 and 13 connected to the actuator 10 and the supply and discharge lines 14 and 15. In this condition the actuator 10 is therefore locked in a fixed position, since neither of its chambers 16 and 17 is connected either to the pump P or to the reservoir T.

The operation of a directional control valve of this type is known to the man skilled in the art and therefore will not be described in detail. What is of interest to show here is that the displacement of the sliding member of the directional control valve 100 from the rest position 0 to one of the two working positions 1 and 2 takes place in a continuous and adjustable manner, whereby the flow areas A_{P} and A_{T} of the working fluid in the supply direction through one of the ports of the actuator 10 and in the discharge direction from the other port, respectively, vary between a nil value and a maximum value as a function of the instantaneous position of the sliding member. The opening characteristic of the fluid flow cross areas, that is to say the law of variation of these areas as a function of the position of the sliding member, is established at the design stage of the directional control valve to satisfy a series of functional requirements such as, for example, the control of the flow rate value, the reduction of leakage, the rapidity of port and the protection against possible overpressures in the circuit.

A directional control valve of the above-described type is not, however, able to control the supply flow area A_{P} and the discharge flow area A_{T} independently from one another, and therefore provides a single degree of freedom for the control of the movement of the actuator, since each position of the sliding member corresponds to a single predetermined value of the ratio A_{P}/A_{T} between the supply and discharge flow areas.

In order to have a further degree of freedom available, it is known to use a control circuit comprising a pair of three-way, three-position, continuously adjustable directional control valves. A circuit of this type is illustrated in FIG. 2 of the attached drawings, in which the same or corresponding components to those of FIG. 1 have been indicated with the same reference numerals. With reference to FIG. 2, a first, continuously adjustable directional control valve 120 is interposed between the first power line 12 and the supply and discharge lines 14 and 15 to put the power line 12 alternatively into communication with the supply line (working position 1) or with the discharge line (working position 2) or to close all three lines 12, 14 and 15 connected thereto (rest position 0). A second, continuously adjustable directional control valve 130 is interposed between the second power line 13 and the supply and discharge lines 14 and 15 to put the power line 13 alternatively into communication with the supply line (working position 1) or the discharge line (working position 2) or to close all three lines 13, 14 and 15 connected thereto (rest position 0).

The adjustment of the directional control valve 120 from the rest position 0 towards the working positions 1 and 2 is controlled by a pair of pilot pressures p₁ₐ and p₂ₐ, which are produced by respective proportional solenoid valves 20a and 21a and act via respective pilot lines 18a and 19a in opposite directions on identical control surfaces S of the sliding member of this directional control valve. In the same way, the adjustment of the directional control valve 130 from the rest position 0 towards the working positions 1 and 2 is controlled by a pair of pilot pressures p_{1b} and p_{2b}, which are produced by respective proportional solenoid valves 20b and 21b and act via respective pilot lines 18b and 19b in opposite directions on identical control surfaces S of the sliding member of this directional control valve.

This arrangement makes it possible to control the position of the two sliding members of the directional control valves independently of one another, and therefore to control the supply flow area and the discharge flow area also independently of one another, but has the disadvantage of requiring the use of four solenoid valves for the control of the two sliding members, with the obvious consequence of a high cost.

A further known solution, illustrated in FIG. 3, provides for the use of four two-way, two-position, continuously adjustable directional control valves with a first pair of directional control valves 121 and 122 interposed between the first power line 12 (port A) and respectively, a supply line 14 (pump P) or a discharge line 15 (reservoir T), and a second pair of directional control valves 131 and 132 interposed between the second power line 13 (port B) and, respectively, the supply line 14 or discharge line 15. Each directional control valve is of the normally-closed type and is controllable by a pilot pressure generated by a respective solenoid valve 221, 222, 231, 232.

In this case, too, the control circuit has the disadvantage of requiring four solenoid valves to pilot the directional control valves.

### SUMMARY OF THE INVENTION

The object of the invention is to provide a circuit for the control of a double-acting fluid pressure actuator which enables to control the supply and discharge flow areas through the two ports of the actuator independently of one another, whilst nevertheless using a smaller number of pilot pressures and, therefore, of solenoid valves intended to generate those pressures, than the prior art.

This object is achieved according to the invention by virtue of a control circuit having the characteristics defined in the characterising part of independent claim 1. Preferred embodiments of the invention are defined in the dependent claims.

### BRIEF DESCRIPTION OF THE DRAWINGS

The characteristics and advantages of the invention will become apparent from the detailed description which follows, given purely by way of non-limitative example, with reference to the attached drawings, in which:

FIG. 1 is a symbol scheme of a circuit for the control of an actuator, comprising a directional control valve with continuously adjustable sliding member according to the prior art;

FIG. 2 is a symbol scheme of a circuit for the control of an actuator, comprising a pair of directional control valves with continuously adjustable sliding member according to the prior art;

FIG. 3 is a symbol scheme of a circuit for the control of an actuator, comprising four directional control valves with continuously adjustable sliding member according to the prior art;

FIG. 4 is a symbol scheme of a circuit for the control of an actuator, comprising a pair of directional control valves with continuously adjustable sliding member according to a first embodiment of the present invention;

FIG. 5 shows the opening characteristics required of the sliding members of the directional control valves of the circuit of FIG. 4;

FIGS. 6 to 8 each show a region of the p₁-p₂ plane of the pilot pressures corresponding to the a respective operating condition of the directional control valves of the circuit of FIG. 4;

FIG. 9 shows all the regions of the p₁-p₂ planes of the pilot pressures corresponding to the different operating conditions of the directional control valves of the circuit of FIG. 4;

FIG. 10 is a symbol scheme of a circuit for the control of an actuator, comprising four directional control valves with continuously adjustable sliding member according to a further embodiment of the present invention;

FIG. 11 shows the opening characteristics of the two directional control valves of the circuit of FIG. 10 controlled by the first pilot signal, as a function of the intensity of this signal; and

FIG. 12 shows the opening characteristics of the two directional control valves of the circuit of FIG. 10 controlled by the second pilot signal, as a function of the intensity of this signal.

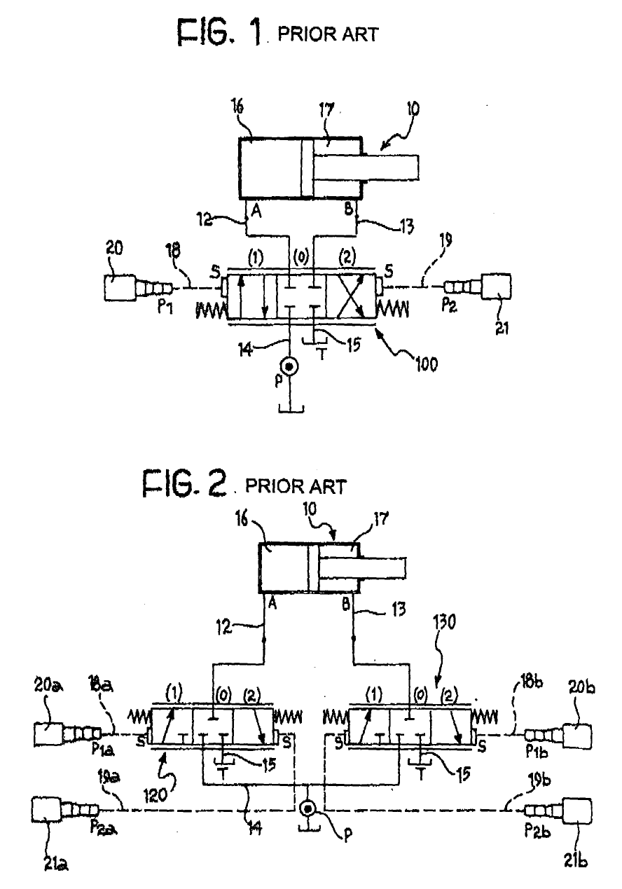

### DETAILED DESCRIPTION OF THE PREFERRED EMBODIMENTS

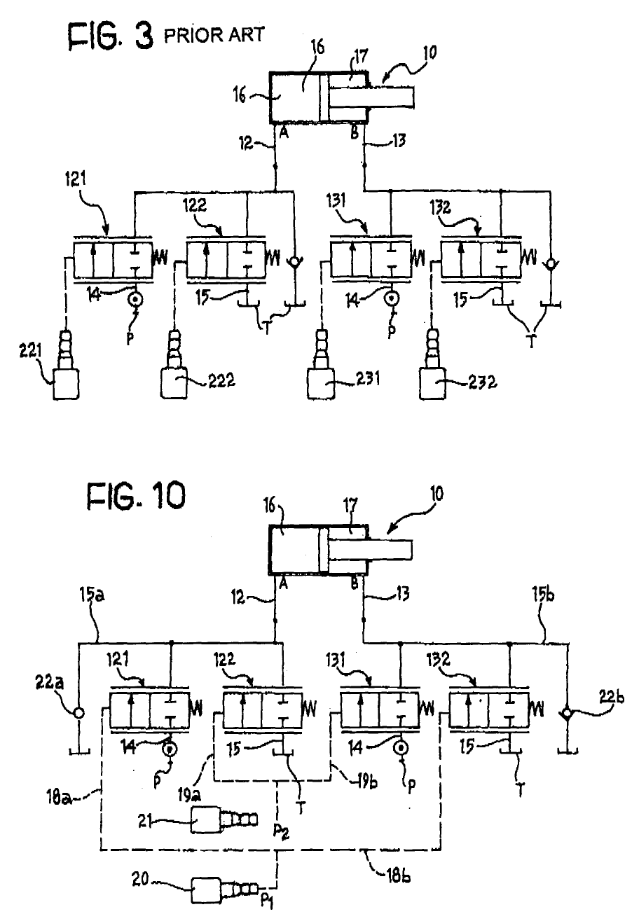

In the following description of the two embodiments of the invention there will be illustrated specifically only the components and features necessary for understanding of the invention, it being clear that for anything not expressly described or mentioned reference will be made to the prior art discussed above, and in particular to the circuit schemes of FIGS. 2 and 3.

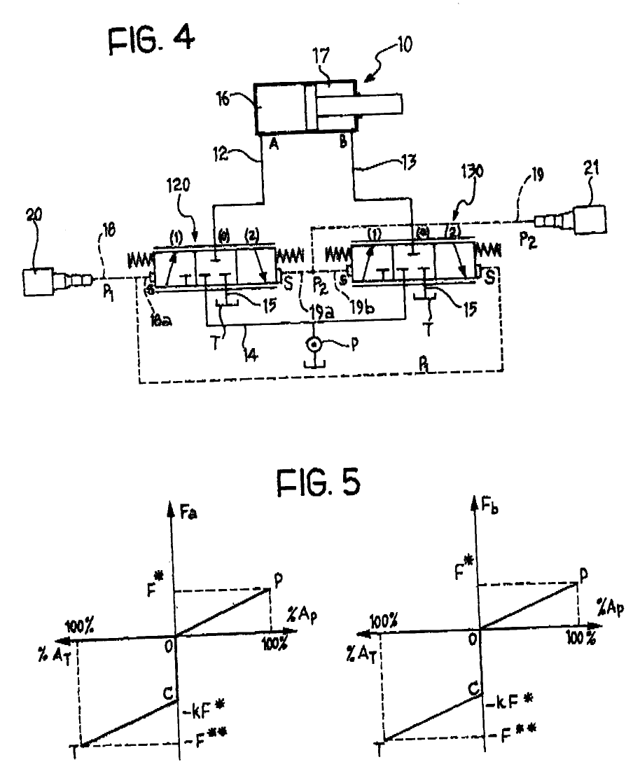

Referring first to the scheme of FIG. 4, where components identical or corresponding to those of FIG. 2 (prior art) have been indicated with the same reference numerals, a control circuit according to the invention, intended to control the movement of a double-acting actuator 10, comprises first and second directional control valves 120 and 130 with continuously adjustable sliding member, which valves are connected on one side with a first power line 12 associated to a port A of the actuator and with a second power line 13 associated to a port B of the actuator, respectively, and on the other side both with a supply line 14 connected to a pump P and with a discharge line 15 connected to a reservoir T.

Each directional control valve 120, 130 can achieve:

a rest position 0 in which it closes both the supply and discharge lines 14, 15 and the associated power line 12 or 13;

a first working position 1 in which it puts the associated power line 12 or 13 into communication with the supply line 14; and

a second working position 2 in which it puts the associated power line 12, 13 into communication with the discharge line 15.

Obviously, as far as continuously adjustable directional control valves are concerned, the shift from the rest condition 0 to either of the working positions 1, 2 can be adjusted so as to vary the supply and discharge fluid flow areas A_{P} and A_{T}, respectively.

A pair of solenoid valves 20 and 21 of proportional type are arranged to generate a pair of pilot pressures p₁ and p₂, which are supplied to the sliding members of the directional control valves 120 and 130 via respective pilot lines 18 and 19, each of which is split into a first pilot line 18a and 19a, respectively, associated to the first directional control valve 120 and a second pilot line 18b and 19b, respectively, associated to the second directional control valve 130.

In particular, the pilot pressure p₁ generated by the solenoid valve 20 acts via the pilot line 18a on a control surface s of the sliding member of the first directional control valve 120 to move this sliding member into the working position 1, and via the pilot line 18b on a control surface S of the sliding member of the second directional control valve 130 (with S>s) to move this sliding member into the working position 2. The pilot pressure p₂ generated by the solenoid valve 21 acts via the pilot line 19a on a control surface S of the sliding member of the first directional control valve 120 to move this sliding member into the working position 2, and via the pilot line 19b on a control surface s of the sliding member of the second directional control valve 130 to move this sliding member into the working position 1.

Where only the pilot pressure p₁ is present and the pressure p₂ is set at 0, the directional control valves 120 and 130 are shifted into the working positions 1 and 2, respectively. The power line 12 therefore receives fluid through the first directional control valve 120 from the supply line 14 and can supply the rear chamber 16 of the actuator 10 through the port A. On the other hand, the power line 13 is put into communication with the discharge line 15, whereby the actuator 10 can discharge fluid from the front chamber 17 through the port B. The rod of the actuator 10 is thus caused to extend.

On the other hand, where only the pilot pressure p₂ is present and the pressure p₁ is set at 0, the ports B and A of the actuator 10 are connected with the supply line 14 and the discharge line 15, respectively, thereby causing the actuator rod to retract.

The circuit is likewise able to assume a so-called floating condition in which both the directional control valves 120, 130 are in the working position 2 wherein they connect both the ports A and B of the actuator 10 to the discharge and therefore allow the free movement under load of the actuator rod. This operating condition can be achieved, for example, by generating pilot pressures p₁ and p₂ equal to one another, by virtue of the fact that each pressure acts on different control surfaces on the two sliding members.

Finally, to lock the rod of the actuator 10 in position it is sufficient to set both the pilot pressures p₁ and p₂ at 0 by deactivating the solenoid valves 20 and 21 in such a way that both the directional control valves 120 and 130 are brought back into the rest position 0 and the power lines 12 and 13 which communicate with the ports A and B of the actuator are thus closed.

It will now be illustrated how the control circuit of the present invention enables an independent adjustment of the two flow areas for the working fluid which is supplied or discharged by the power lines 12 and 13 as a result of the movement of the sliding members of the two directional control valves. In conformity with the symbols used above, for each of the sliding members of the directional control valves 120, 130 the fluid flow area to the associated power line 12, 13 will be indicated A_{P} when the line is connected to the supply, and the fluid flow area from the associated power line 12, 13 will be indicated A_{T} when the line is connected to the discharge.

Indicating Fₐ the resultant force on the sliding member of the first directional control valve 120 and F_{b} the resultant force on the sliding member of the second directional control valve 130, the static equilibrium equations for the two sliding members are:

Fₐ=p₁s−p₂S, and (1)

F_{b}=p₂s−p₁S. (2)

The opening characteristics of the sliding members of the two directional control valves shown in FIG. 5 define the variation of the resultant force on each sliding member as a function of the flow area, this latter being expressed as a percentage with respect to the maximum area (corresponding to the condition in which the port is completely open). In the example under discussion, the two sliding members have identical characteristics in which the following three sections can be noted:

a first section lying between points O and P and corresponding to the working position 1 of the sliding member, that is to say to connection of the associated power line with the supply, in which the resultant force on the sliding member increases linearly between 0 and a maximum value F* as the flow area A_{P} increases between 0 and its maximum value (100%);

a second section lying between points O and C and relating to the rest condition 0 of the sliding member, in which the fluid flow area is kept at 0 up to a value of the force equal to −KF*, where K is a non-dimensional coefficient given by the ration S/s between the control surfaces of the two pilot pressures acting on each sliding member; and

a third section lying between points C and T and corresponding to the working position 2 of the sliding member, that is to say to connection of the associated power line with the discharge, in which the resultant force on the sliding member decreases linearly between the said value −KF* and a value −F** as the flow area AT increases between 0 and its maximum value (100%).

To provide a first operating condition F1, in which the first power line 12 (port A) is connected with the supply line 14 and the supply fluid flow area A_{P} can be varied, whilst the second power line 13 (port B) is kept close, it is necessary to adjust the force Fₐ on the sliding member of the first directional control valve 120 along the first section of the associated characteristic and the force F_{b} on the sliding member of the second directional control valve 130 along the second section of the associated characteristic.

The working condition F1 is therefore defined by the system of inequalities:

Fₐ≧0 (3)

−KF*≦F_{b}≦0. (4)

Substituting in inequalities (3) and (4) the expressions (1) and (2) of the forces Fₐ and F_{b} as a function of the pilot pressures p₁ and p₂, the system of inequalities becomes:

p₂≦p₁/K (5)

p₂≧Kp₁−KF*/s. (6)

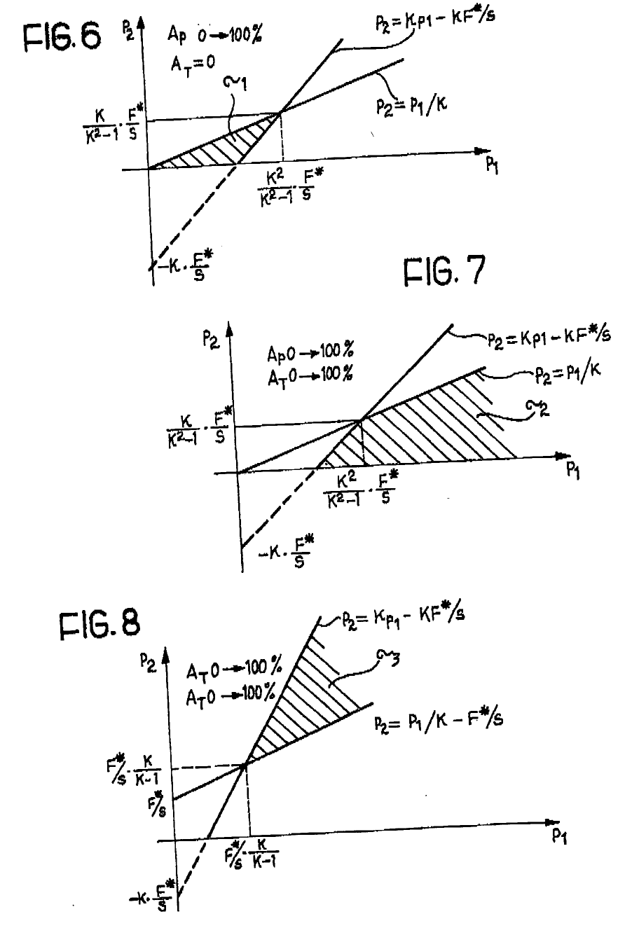

In FIG. 6 there is illustrated in broken outline a region σ₁ of the p₁-p₂ plane of the pilot pressures of the directional control valves, corresponding to the graphic solution of the above system.

Therefore, in order to bring the circuit into the operating condition F1 defined above it is necessary to control the two solenoid valves 20 and 21 in such a way that they generate a pair of pilot pressures p₁ and p₂ the values of which satisfy the system of inequalities (5) and (6), that is to say they lie between limits graphically identified by the region σ₁ of the plane p₁-p₂.

To achieve a second operating condition F2, in which the power lines 12 and 13 are connected with the supply line 14 and the discharge line 15, respectively, and both the supply fluid flow area A_{P} and the discharge fluid flow area A_{T} can be varied, it is necessary to adjust the force Fₐ on the sliding member of the first directional control valve 120 along the first section of the associated characteristic and the force F_{b} on the sliding member of the second directional control valve 130 along the third section of the associated characteristic.

The operating condition F2 is therefore defined by the system of inequalities:

Fₐ≧0 (7)

F_{b}≦−KF* (8)

By substituting into inequalities (7) and (8) the expressions (1) and (2) of the forces Fₐ and F_{b} as a function of the pilot pressures p₁ and p₂, and solving with respect to p₂, the system of inequalities becomes:

p₂≦p₁/K (9)

p₂≦Kp₁−KF*/s. (10)

In FIG. 7 there is illustrated in broken outline a region σ2 of the p₁-p₂ plane of the pilot pressures of the directional control valves, corresponding to the graphic solution of the system of inequalities (9) and (10).

To achieve a third operating condition F3, in which both the power lines 12 and 13 are connected to the reservoir T through the discharge line 15 and the discharge fluid flow area A_{T} can be varied for both the lines, it is necessary to adjust both the force Fₐ and the force F_{b} along the third section of the characteristics of the respective sliding members.

The operating condition F3 is therefore defined by the system of inequalities:

Fₐ≦−KF* (11)

F_{b}≦−KF* (12)

By substituting into the inequalities (11) and (12) the expressions (1) and (2) of the forces Fₐ and F_{b} as a function of the pilot pressures p₁ and p₂ and solving with respect to p₂, the system of inequalities becomes:

p₂≧p₁/K−F*/s (13)

p₂≦Kp₁−KF*/s (14)

In FIG. 8 there is illustrated in broken outline a region σ₃ of the p₁-p₂ plane of the pilot pressures of the directional control valves, corresponding to the graphic solution of the system of inequalities (13) and (14).

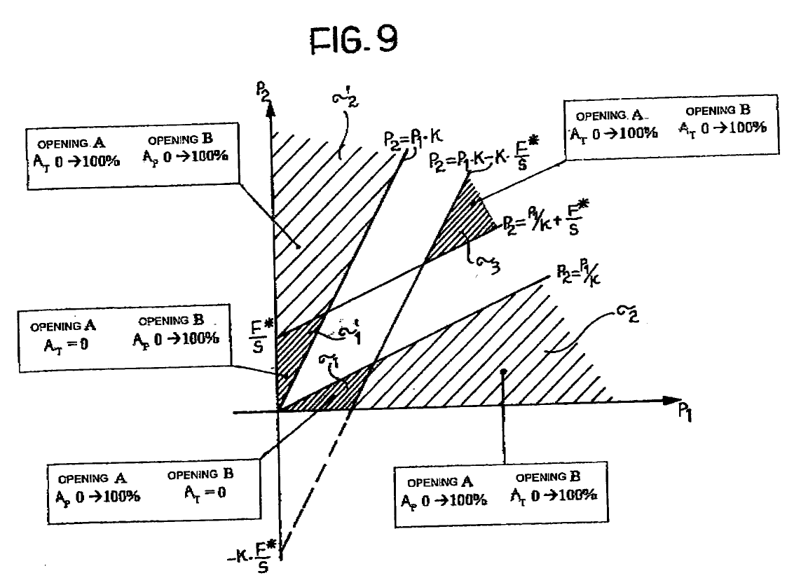

In FIG. 9 the three regions σ₁, σ₂ and σ₃ defined above are shown altogether, as well as two further regions σ₁′ and σ₂′ corresponding to two further operating conditions F1′ and F2′, respectively, which are symmetrical with respect to the conditions F1 and F2, that is, they differ from the latter conditions in that the ports A and B are a discharge port and a supply port, respectively, rather than a supply port and a discharge port. Due to the symmetry of the circuit and of the operating conditions F1′ and F2′, the regions σ₁′ and σ₂′ are symmetrical to the regions σ₁ and σ₂ with respect to the principal diagonal of the p₁-p₂ plane.

The characteristic of symmetry of the circuit is certainly advantageous, but not essential, for applying the present invention, and therefore the invention also encompasses the case of directional control valves with sliding members having operating characteristics different from one another. In the same way, the invention is to be intended as relating also to the case of two directional control valves the sliding members of which have different operating characteristics from those described above. Finally, although reference has been made so far to an arrangement with two directional control valves each having a single sliding member, it is clear that the invention can be applied equally to a single directional control valve provided with two continuously adjustable sliding members.

Referring now to the circuit scheme of FIG. 10, where components identical or corresponding to those of FIG. 3 (prior art) have been indicated with the same reference numerals, in order to control the movement of a double-acting actuator 10 there are provided four two-way, two-position, normally-closed directional control valves with continuously adjustable sliding member, indicated 121, 122, 131 and 132, respectively.

The first two directional control valves 121 and 122 are associated with the first power line 12 connected to the port A of the actuator 10 and control the connection of this power line with the supply (pump P) and the discharge (reservoir T), respectively. The second two directional control valves 131 and 132 are associated with the second power line 13 connected to the port B and control the connection of this power line with the supply (pump P) and with the discharge (reservoir T), respectively.

The first and fourth directional control valves 121 and 132 are both controlled by a first pilot pressure p₁ generated by a first solenoid valve 20 and transmitted via a first pair of pilot lines 18a and 18b to the sliding members of the directional control valves 121 and 132, respectively. The second and third directional control valves 122 and 131 are both controlled by a second pilot pressure p₂ generated by a second solenoid valve 21 and transmitted via a second pair of pilot lines 19a and 19b to the sliding members of directional control valves 122 and 131, respectively.

The first solenoid valve 20 thus controls, by means of the pilot pressure p₁, the connection of the first power line 12 with the supply and of the second power line 13 with the discharge, whilst the second solenoid valve 21 controls, by means of the pilot pressure p₂, the connection of the first power line 12 with the discharge and of the second power line 13 with the supply.

As far as directional control valves with continuously adjustable sliding members are concerned, that is to say, valves in which the shift from the rest position (closed valve) to the working position (open valve) is controlled by the equilibrium between the pilot pressure acting on the sliding member of the directional control valve and the biasing action of a spring which tends to bring the sliding member back into the rest position, the fluid flow area A can be adjusted between a nil value and a maximum value.

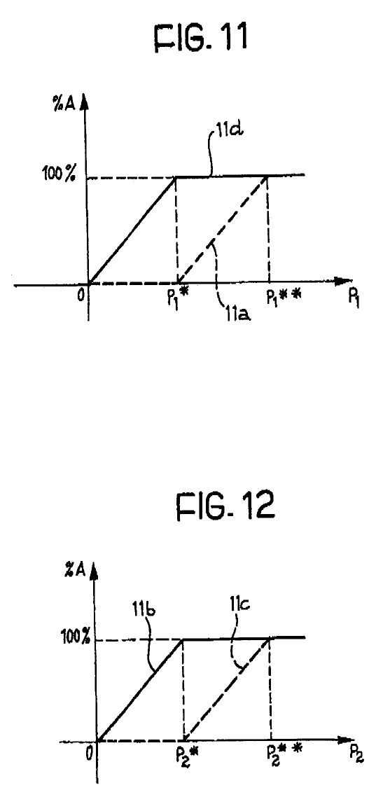

In particular, in the embodiment described here, the springs of the first and third directional control valves 121 and 131 have a greater preload than those of the remaining two directional control valves 122 and 132, as can be inferred by the opening characteristics of the four directional control valves shown in FIGS. 11 and 12.

With reference first to FIG. 11, for values of the first pilot pressure p₁ lying between 0 and a first limit value p₁*, the first directional control valve 121 remains closed and the fourth directional control valve 132 regulates the connection of the second power line 13 with the discharge. For values lying between the first limit value p₁* and a second limit value p₁**, the fourth directional control valve 132 is fully open and the first directional control valve 121 regulates the connection of the first power line 12 with the supply. Above the value p₁** both the directional control valves 121 and 132 are fully open.

Referring now to FIG. 12, for values of the second pilot pressure p₂ lying between 0 and a first limit value p₂*, the third directional control valve 131 remains closed and the second directional control valve 122 regulates the connection of the first power line 12 with the reservoir. For values lying between the first limit value p₂* and a second limit value p₂**, the second directional control valve 122 is fully open and the third directional control valve 131 regulates the connection of the third power line 13 with the supply. Above the value p₂** both the directional control valves 122 and 131 are fully open.

Some operating conditions of the circuit according to this further embodiment of the invention will now be described with reference to FIGS. 10 to 12.

In order to control the extension of the rod of the actuator 10, only the first pilot pressure p₁ is varied, while the second pilot pressure p₂ is kept at 0. In this way, in fact, the directional control valves 121 and 132, respectively, control the connection of the actuator port A with the supply and of the actuator port B with the discharge.

When a resisting load acts upon the actuator rod, it is necessary for the first solenoid valve 20 to generate a pilot pressure value greater than p₁*, whereby the first directional control valve 121 puts the port A into communication with the supply. The extension speed of the rod can be adjusted, as a function of the pilot pressure p₁, between a nil value (for p₁=p₁*) and a maximum value (for p₁*≧p₁**).

On the other hand, when a pulling load acts upon the actuator rod, it is necessary for the first solenoid valve 20 to generate a pilot pressure value less than p₁*, whereby only the fourth directional control valve 132 controlling the discharge port is kept open. In this case, also, the extension speed of the rod can be adjusted, as a function of the pilot pressure p₁, between a nil value (for p₁=0) and a maximum value (for p₁=p₁*).

In order to avoid cavitation phenomena in case of pulling load, there is provided between the actuator port A and the reservoir T a further power line 15a in which a first check valve 22a is arranged which allows fluid to flow only from the reservoir to the actuator.

In order to control retraction of the rod of the actuator 10, only the second pilot pressure p₂ is varied, while the first pilot pressure p₁ is kept at 0. In this way, in fact, the directional control valves 122 and 131, respectively, control the connection of the actuator port A with the discharge and of the actuator port B with the supply. In a similar manner to what has been explained above in case of extension of the rod, the second solenoid valve 21 must generate a pilot pressure value greater than p₂* when a resisting load occurs and less than p₂* when a pulling load occurs. Moreover, in order to avoid cavitation phenomena in case of pulling load, there is provided between the actuator port B and the reservoir T a further power line 15b in which a second check valve 22b is arranged which allows fluid to flow only from the reservoir to the actuator.

Finally, the floating operating condition can be achieved by generating pilot pressure signals p₁ and p₂ lower than p₁* and p₂*, respectively, in such a way that the directional control valves 121 and 131 associated with the supply P are closed and only the directional control valves 122 and 132 associated with the discharge T are open.

Naturally, the principle of the invention remaining unchanged, embodiments and details of construction can be widely varied with respect to those described and illustrated purely by way of non-limitative example.

What is claimed is:

1. An electrohydraulic circuit for control of a fluid pressure actuator having first and second chambers each provided with respective ports; the circuit comprising
first and second power lines connected to the port of the first actuator chamber and to the port of the second actuator chamber, respectively;
at least one supply line and at least one discharge line connected to a supply source and to a discharge reservoir, respectively;
at least one first sliding member valve interposed between the first power line and the supply and discharge lines and capable of putting the port of the first actuator chamber into communication with the supply or with the discharge under the control of pilot pressure signals transmitted to the said at least one first sliding member valve by a first pair of pilot lines; and
at least one second sliding member valve interposed between the second power line and the supply and discharge lines and capable of putting the port of the second actuator chamber into communication with the supply or with the discharge under the control of pilot pressure signals transmitted to the said at least one second sliding member valve by a second pair of pilot lines;
wherein the one line of the first pair of pilot lines and the one line of the second pair of pilot lines are arranged to transmit the same first pilot pressure signal, and the other line of the first pair of pilot lines and the other line of the second pair of pilot lines are arranged to transmit the same second pilot pressure signal, whereby the actuator can be controlled by means of the first and second pilot pressure signals.

2. The control circuit of claim 1, comprising a first, continuously adjustable sliding member valve interposed between the first power line and the supply and discharge lines, and a second, continuously adjustable sliding member valve interposed between the second power line and the supply and discharge lines, wherein each of the first and second sliding member valves has first and second control surfaces, different from one another, on each of which a respective first or second pilot pressure signal acts.

3. The control circuit of claim 2, wherein the first control surface of the first sliding member valve and the second control surface of the second sliding member valve are both subject to the first pilot pressure signal, in such a way that the first signal tends to shift the first sliding member valve into a first working position and the second sliding member valve into a second working position; and the second control surface of the first sliding member valve and the first control surface of the second sliding member valve are both subject to the second pilot pressure signal, in such a way that the second signal tends to shift the first sliding member valve into a second working position and the second sliding member valve into a first working position; whereby in the first working position the two sliding member valves put the associated first or second power line into communication with the supply line and close the discharge line, whilst in the second working position the two sliding member valves put the associated first or second power line into communication with the discharge line and close the supply line.

4. The control circuit of claim 3, wherein the first control surfaces of the first and second sliding member valves are smaller than the second control surfaces.

5. The control circuit of claim 4, wherein each of the two sliding member valves is also capable of assuming a rest position in which the sliding member valve closes all the lines connected thereto.

6. The control circuit of claim 4, wherein each of the two sliding member valves has an opening characteristic such that the sliding member valve can be shifted into the first working position under a resultant force of given direction which increases as the flow area of the fluid coming from the supply increases, and into the second working position under an opposite resultant force which increases as the flow area of the fluid flowing towards the discharge increases.

7. The control circuit of claim 1, comprising a first pair of continuously adjustable sliding member valves interposed between the first power line and the supply and discharge lines, respectively, and a second pair of continuously adjustable sliding member valves interposed between the second power line and the supply and discharge lines, respectively, wherein the sliding member valves are of the two-way, two-position type.

8. The control circuit of claim 7, wherein the sliding member valves are of the normally-closed type.

9. The control circuit of claim 8, wherein in each pair of sliding member valves controlled by the same pilot pressure signal, the sliding member valve associated with the supply is arranged to shift from the closed position to the open position under the effect of a pilot pressure greater than that necessary to shift the sliding member valve associated with the discharge.

10. The control circuit of claim 7, also comprising a further pair of power lines which connect the first and second actuator chambers to the discharge and are each provided with a respective check valve arranged to prevent flow from the respective actuator chamber to the discharge.

11. The control circuit of claim 1, wherein each of the two pilot pressure signals is generated by a solenoid valve.
